(19) United States
(12) Patent Application Publication
(10) Pub. No.: US 2018/0121152 A1
(43) Pub. Date: May 3, 2018

(54) METHOD AND SYSTEM FOR GENERATING MULTIPLE VIRTUAL IMAGE DISPLAYS

(71) Applicant: International Business Machines Corporation, Armonk, NY (US)

(72) Inventors: Vijay Ekambaram, Tamilnadu (IN); Sarbajit K. Rakshit, Kolkata (IN)

(21) Appl. No.: 15/339,980

(22) Filed: Nov. 1, 2016

(51) Int. Cl. G06F 3/14; G06F 3/01; G09G 3/00

(52) U.S. Cl. CPC G06F 3/1446; G06F 3/017; G09G 2300/026; G09G 3/001; G09G 2354/00; G06F 3/013

(57) ABSTRACT

The present invention is a system, computer program product, and method for generating multiple virtual image displays. The system includes a housing having an open end and a closed end with a plurality of sidewalls extending between the open end and the closed end. There is a main display area at the closed end and a sidewall display area on each sidewall. The system further includes a computer within the housing operably connected to the main display area and sidewall display areas. The computer is programmed, structured, and/or configured to generate a plurality of virtual display areas opposing each sidewall display area and a plurality of secondary virtual display areas extending outwardly from the virtual display areas.

### BACKGROUND

### 1. Field of the Invention

The present invention relates generally to a method and system for generating virtual image displays, and more particularly to a method and system for creating and aggregating multiple virtual image displays.

### 2. Background of Art

Conventional image displays screens, such as LED or LCD panels, are limited in the number of image display areas. The image display areas are limited to the number of physical panels. Therefore, to simultaneously obtain multiple image display areas, a user must have multiple physical panels. Consequently, acquiring multiple physical panels is costly and cumbersome.

To solve the problems with conventional physical image display screens, virtual image displays have been developed and utilized. Conventional lenses and reflective elements have been used to generate a virtual image display. However, virtual image displays generally only exhibit a single virtual image which is a magnified version of the real image. Therefore, there still exists a need for a system providing multiple virtual image displays that can be aggregated to provide one content display area.

### 3. Objects and Advantages

It is a principal object and advantage of the present invention to provide multiple virtual display areas.

It is another object and advantage of the present invention to limit the number of physical displays necessary to view multiple images.

It is yet another object and advantage of the present invention to aggregate the multiple virtual display areas into one content display area so that one continuous stream of content can be viewed thereon.

It is a further object and advantage of the present invention to provide a system for creating multiple virtual displays that can be unfolded into a substantially planar configuration.

It is an added object and advantage of the present invention to provide a system for generating multiple virtual displays wherein the content displayed can be altered with gestures, eye movement and other like behaviors.

Other objects and advantages of the present invention will in part be obvious and in part appear hereinafter.

### SUMMARY OF THE INVENTION

The present invention is a system and method for generating multiple virtual image displays. The system includes a housing having an open end and a closed end with a plurality of sidewalls extending between the open end and the closed end. There is a main display area at the closed end and a sidewall display area on each sidewall. The system further includes a computer within the housing operably connected to the main display area and sidewall display areas. The computer is configured to generate a plurality of virtual display areas opposing each sidewall display area and a plurality of secondary virtual display areas extending outwardly from the virtual display areas.

The method comprises the step of first providing a multiple virtual display system comprising a housing having an open end and a closed end with a plurality of sidewalls extending between the open end and the closed end. There is a main display area at the closed end and a sidewall display area on each sidewall. The system further includes a computer within the housing operably connected to the main display area and sidewall display areas. The method further comprises the steps of generating a virtual display area opposing each sidewall display area, generating a plurality of secondary virtual display areas extending outwardly from the virtual display areas, and aggregating the main display area, virtual display areas, and secondary virtual display areas to create a virtual content display area.

### BRIEF DESCRIPTION OF THE DRAWINGS

The present invention will be more fully understood and appreciated by reading the following Detailed Description in conjunction with the accompanying drawings, in which:

FIG. 1 is a front isometric view of an embodiment of the multiple virtual display system;

FIG. 2a is a front isometric view of an alternative embodiment of the multiple virtual display system;

FIG. 2b is a front isometric view of an alternative embodiment of the multiple virtual display system;

FIG. 2c is a front isometric view of an alternative embodiment of the multiple virtual display system;

FIG. 3 is a front isometric view of an embodiment of the multiple virtual display system and resulting content display area;

FIG. 4 is a diagram depicting an embodiment of a method for creating multiple virtual displays;

FIG. 5 is a front isometric view of an alternative embodiment of the multiple virtual display system and resulting content display area; and

FIG. 6 is a flowchart of one embodiment of a method for generating multiple virtual image displays.

### DETAILED DESCRIPTION

Referring to the Figures, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

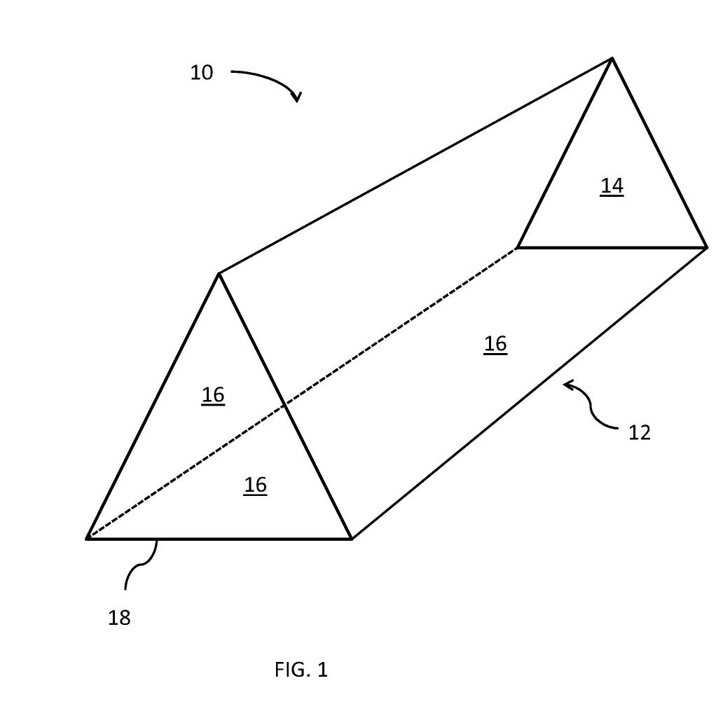

Referring again to the drawings, wherein like reference numerals refer to like parts throughout, there is seen in FIG. 1 a system 10 for generating multiple virtual displays. The system 10 comprises a housing 12 having a closed end 14 and a plurality of connected sidewalls 16 extending therefrom. The sidewalls 16 extend from the closed end 14 to an open end 18 of the housing 12. Thus, the housing 12 is tube-like with an open end 18 and a closed end 14. Further, the sidewalls 16 of the housing 12 may be permanently connected or releasably connected. In an embodiment wherein the sidewalls are releasably connected, a user can release the sidewalls and unfold the tube-like housing until it is substantially planar.

The housing 12 is dimensioned such that a feature of the closed end 14 is different than a feature of the open end 18. The feature can be an area, diameter, perimeter, or any like geometries. In the depicted embodiment, the housing 12 is tapered such that the feature, the area for example, of the open end 18 is larger than the area of the closed end 14. In this embodiment, the larger open end 18 allows a user to look into the housing 12 from a distance. This configuration is critical as the user views the multiple virtual image displays by looking into the housing 12, as discussed later.

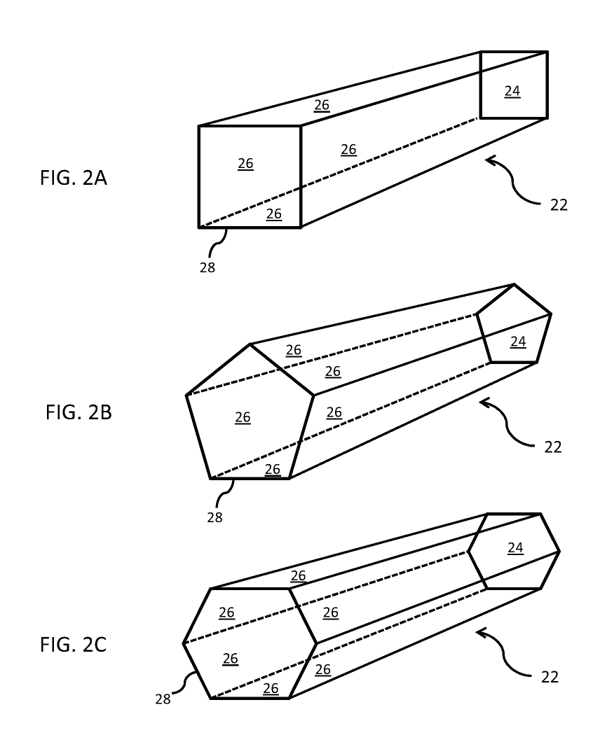

In the embodiment depicted in FIG. 1, a cross-section of the housing 12 is triangular. However, referring now to FIGS. 2A-C, the cross-section of the housing 22 may comprise any polygonal shape, such as a square, rectangle, pentagon, hexagon, etc. FIG. 2A depicts a housing 22 having a rectangular cross-section. FIG. 2B depicts a housing having a pentagonal cross-section. FIG. 2C depicts a housing having a hexagonal cross-section. The embodiments shown in FIGS. 2A-C all comprise a closed end 24 with a feature, the area for example, that is smaller than the area of the open end 28 thereby providing the optimal angular configuration to generate and view the multiple virtual displays, as described below.

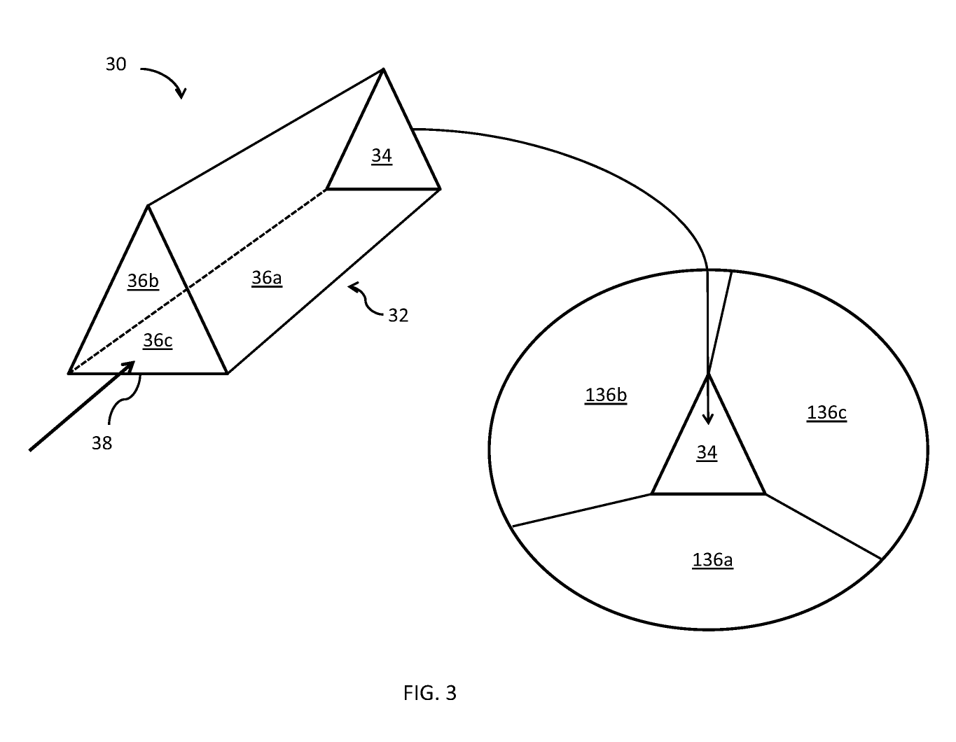

Each sidewall 16 shown in FIG. 1 further comprises a sidewall display area on the interior of the housing 12. The sidewall display areas 36a, 36b, 36c can be seen in FIG. 3. FIG. 3 is a front isometric view of an embodiment of the multiple virtual display system and resulting content display area. In the depicted embodiment, the sidewall display areas 36a, 36b, 36c are shown on the interior of the housing 32. Due to the polygonal geometric configuration of the housing 32, the sidewall display areas 36a, 36b, 36c are in an angular relationship. The angular relationship between the sidewall display areas 36a, 36b, 36c facilitates the creation of multiple virtual displays.

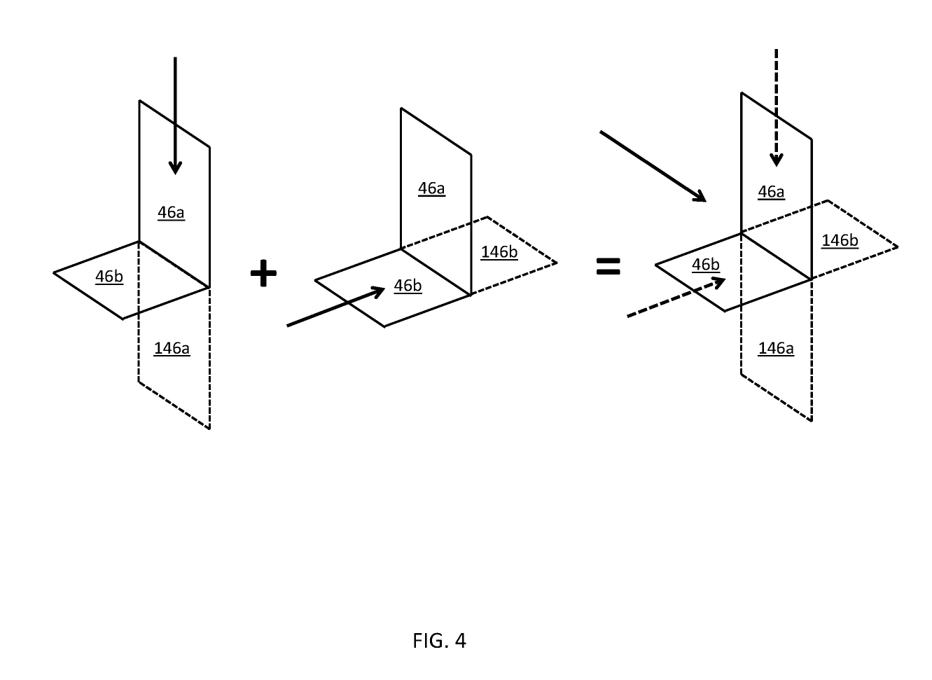

Referring now to FIG. 4, there is shown a diagram depicting an embodiment of virtual display creation. First, a virtual display is generated opposing each physical display. In the example shown in FIG. 4, a first physical display 46a perpendicularly intersects and connects to a second physical display 46b. A first virtual display 146a is created opposing the first physical display 46a. The first virtual display 146a can be viewed when the user's view is parallel to the first physical display 46a. Similarly, a second virtual display 146b can be created opposing the second physical display 46b. The second virtual display 146b can be seen when the user's view is positioned along the second physical display 46b. When both the first virtual display 146a and the second virtual display 146b are created, the user may view both virtual displays 146a, 146b when the user's view is directed towards the intersection of the physical displays 46a, 46b.

The principal illustrated in FIG. 4 can be translated to the embodiment shown in FIG. 3. By changing the dimensions and angular geometries of the physical displays 46a, 46b shown in FIG. 4 to the configuration of the sidewall display areas 36a, 36b, 36c of the housing 32 shown in FIG. 3, the system 30 can produce arc-shaped virtual display areas 136a, 136b, 136c. In the triangular housing 32 embodiment shown in FIG. 3, a first sidewall display area 36a generates a first virtual display area 136a, a second sidewall display area 36b generates a second virtual display area 136b, and a third sidewall display area 36c generates a third virtual display area 136c. When a user looks into the housing 32, the user sees all three virtual display areas 136a, 136b, 136c surrounding the main display area 34. This effect occurs with any polygonal shaped housing, including those shown in FIGS. 2A-C.

Particularly, the principal illustrated in FIG. 4 can also be translated to the rectangular housing 22 embodiment shown in FIG. 2A. Unlike the other polygonal housing embodiments, the rectangular housing 22 comprises a cross-section wherein the sidewalls 26 are either perpendicular or parallel to each other. However, the feature of the open end 28 remains different from the feature of the closed end 24 such that the sidewalls 26 are, in fact, not parallel. This configuration allows the rectangular housing 22 embodiment shown in FIG. 2A to exhibit the necessary angular geometries required to generate multiple virtual display areas.

In one embodiment, the system comprises a computer located within the housing. The computer may include components such as a processor, a power source, a transmitter, a memory, and a controller. In one embodiment, the computer comprises computer readable program instructions, which when executed by the processor, create the virtual display areas 136a, 136b, 136c, as shown in FIG. 3.

In one embodiment, the processor executes computer readable program instructions to mimic mirror-like reflection on each sidewall display area 36a, 36b, 36c in FIG. 3. As a result, the virtual display areas 136a, 136b, 136c generated from the sidewall display areas 36a, 36b, 36c exhibit recursive virtual display areas, much like an infinity mirror effect. The infinity mirror effect is created when two parallel reflective surfaces reflect light an infinite number of times, thus producing recursive reflections that appear to recede straight into an infinite distance at the center of the mirrors. However, when the mirrors are not exactly parallel, the reflections will curve to one side as they recede.

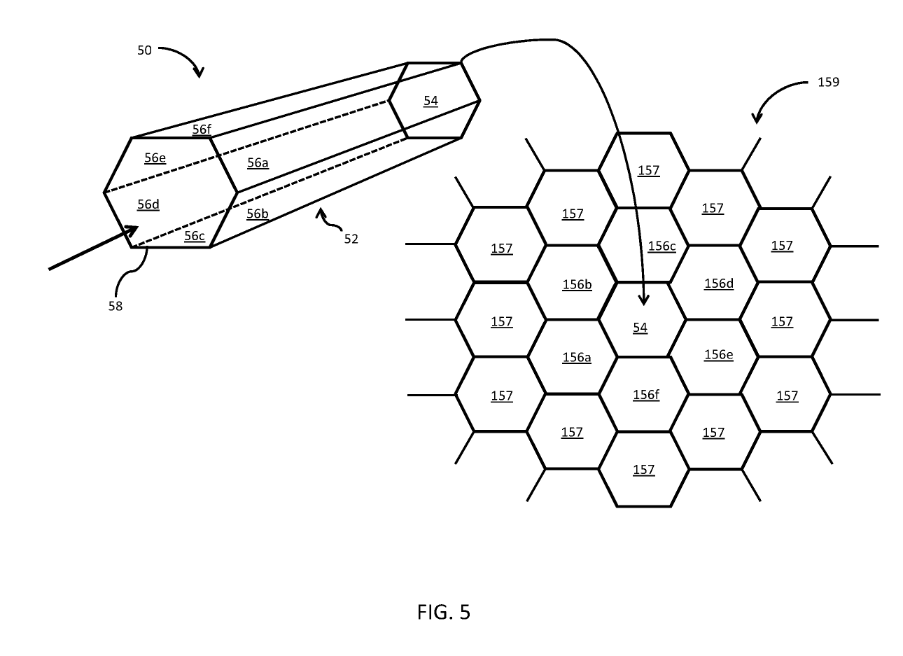

As applied to the present invention and depicted in FIG. 5, the sidewall display areas 56a, 56b, 56c, 56d, 56e, 56f generate the virtual display areas 156a, 156b, 156c, 156d, 156e, 156f, respectively, which in turn generate secondary virtual display areas 157 based on computer readable program instructions, which when executed by the processor, cause the sidewall display areas 56a, 56b, 56c, 56d, 56e, 56f to mimic infinity mirror properties. Referring again to FIG. 5, the main display area 54 is not altered in the creation of the virtual display areas 156a, 156b, 156c, 156d, 156e, 156f and secondary virtual display areas 157. Therefore, when a user looks into the open end 58 of the housing 52, the user sees the main display area 54 surrounded by the virtual display areas 156a, 156b, 156c, 156d, 156e, 156f. The user additionally sees the secondary virtual display areas 157 surrounding the virtual display areas 156a, 156b, 156c, 156d, 156e, 156f. However, the embodiment shown in FIG. 5 is not meant to be limiting. As discussed above, the principal effect of the infinity mirror is that the reflections recede to infinity. Thus, mimicking the infinity mirror effect, numerous secondary virtual displays 157 may be created and appear to extend to infinity outwardly from the main display area 54.

The virtual display areas 156a, 156b, 156c, 156d, 156e, 156f and the main display area 54 can be aggregated with the secondary virtual display areas 157 in order to create one virtual content display area 159. Content transmitted by the processor is projected onto the main display area 54, the virtual display areas 156a, 156b, 156c, 156d, 156e, 156f, and the secondary virtual display areas 157. Thus, when the aforementioned display areas are aggregated, the virtual content display area 159 will show continuous content. However, the content transmitted from the processor to the virtual content display area 159 may also be isolated.

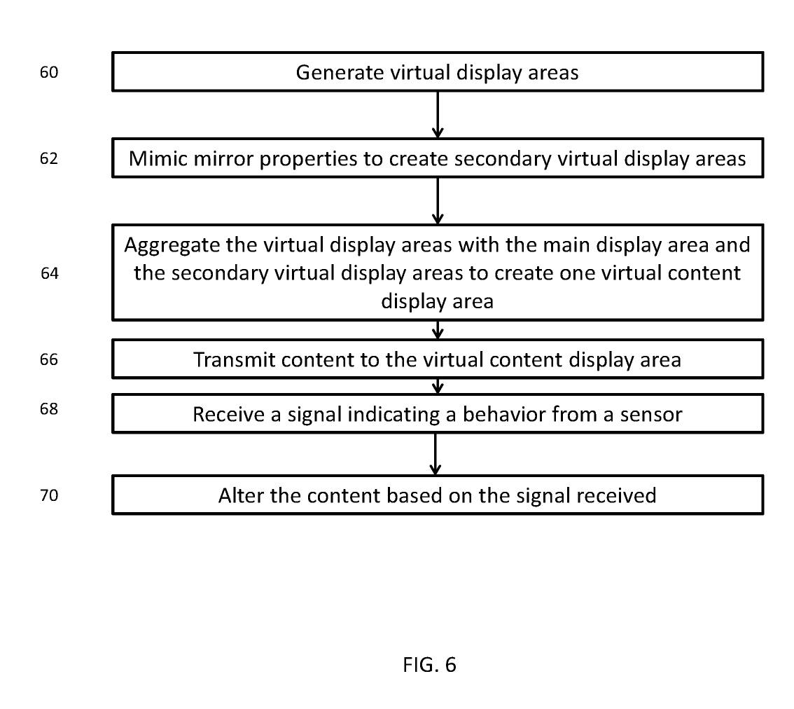

Referring now to FIG. 6, there is shown a flowchart of one embodiment of a method for generating a virtual content display area. The embodiment shown in FIG. 6 comprises the first step 60 of generating virtual display areas opposing the sidewall display areas. As stated above and depicted in FIG. 4, computer readable program instructions are executed by the processor to create virtual display areas 146a, 146b opposing the sidewall display areas 46a, 46b such that all virtual display areas 146a, 146b can be viewed at once. Once the virtual display areas are created, the second step 62 of the embodiment shown in FIG. 6 includes mimicking mirror properties to generate secondary virtual display areas. As also stated above, the computing system can be programmed and/or configured with instructions to generate recursive secondary virtual display areas. As shown in FIG. 5, the secondary virtual display areas 157 surround the virtual display areas 156a, 156b, 156c, 156d, 156e, 156f and extend outwardly, conceivably to infinity.

The third step 64 of the embodiment shown in FIG. 6, includes aggregating the virtual display areas with the main display area and the secondary virtual display areas. As shown in FIG. 5, the virtual display areas 156a, 156b, 156c, 156d, 156e, 156f are aggregated with the main display area 54 and the secondary virtual display areas 157 to generate one virtual content display area 159. At the next step 66, content is projected on the virtual content display area. Content is transmitted by the processor to the virtual content display area. As shown in FIG. 5, a user can view the content on the virtual content display area 159 by directing his/her view through the open end 58 of the housing 52. At the final step 68 in the embodiment shown in FIG. 6, the content projected on the virtual content display area may be altered. For example, the content can be enlarged, minimized, scrolled through and the like. Alterations to the content can be controlled by the user. In one embodiment, the housing or computer may comprise sensors that detect gestures, eye movements and other like behavior. The sensors can transmit a signal to the processor to alter the transmitted content accordingly.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A system for multiple virtual image displays, comprising:
a housing having an open end and a closed end with a plurality of sidewalls extending between the open end and the closed end;
a main display area at the closed end;
a sidewall display area on each sidewall;
a computer within the housing operably connected to the main display area and sidewall display areas;
wherein the computer is configured to generate a plurality of virtual display areas opposing each sidewall display area; and
a plurality of secondary virtual display areas extending outwardly from the virtual display areas.

2. The system of claim 1, wherein a cross-section of the housing is polygon shaped.

3. The system of claim 1, wherein a cross-section of the housing is triangular.

4. The system of claim 1, wherein a cross-section of the housing is hexagonal.

5. The system of claim 1, wherein a feature of the open end is different than a feature of the closed end.

6. The system of claim 1, wherein the housing is tapered from the open end to the closed end.

7. The system of claim 1, wherein two of the plurality of sidewalls are removably connected.

8. The system of claim 1, further comprising a sensor within the housing.

9. The system of claim 8, wherein the sensor detects gestures and transmits a signal to the computer.

10. The system of claim 8, wherein the sensor detects eye movement and transmits a signal to the computer.

11. A method for providing multiple virtual image displays, comprising the step of:
providing a multiple virtual display system comprising a housing having an open end and a closed end with a plurality of sidewalls extending between the open end and the closed end;
a main display area at the closed end; a sidewall display area on each sidewall; and a computer within the housing operably connected to the main display area and sidewall display areas;
generating a virtual display area opposing each sidewall display area;
generating a plurality of secondary virtual display areas extending outwardly from the virtual display areas; and
aggregating the main display area, virtual display areas, and secondary virtual display areas to create a virtual content display area.

12. The method of claim 11, further comprising the steps of:
providing a sensor within the housing;
sensing eye movement with the sensor; and
transmitting a signal from the sensor to the computer.

13. The method of claim 11, further comprising the steps of:
providing a sensor within the housing;
sensing gestures with the sensor; and
transmitting a signal from the sensor to the computer.

14. The method of claim 11, further comprising the step of projecting content onto the virtual content display area.

15. The method of claim 14, wherein the content is continuous.

16. The method of claim 14, wherein the content is isolated.

17. A computer program product providing content on multiple virtual displays, the computer program comprising a computer readable storage medium having program instructions embodied therewith, wherein the computer readable storage medium is not a transitory signal per se, the program instructions are readable by a computer to cause the computer to perform a method comprising the steps of:
generating a plurality of virtual display areas;
generating a plurality of secondary virtual display areas extending outwardly from the virtual display areas; and
aggregating the virtual display areas and secondary virtual display areas to create a virtual content display area.

18. The computer program product of claim 17, wherein the program instructions cause the computer to perform a method comprising the further steps of:
sensing gestures with a sensor operably connected to the computer; and
transmitting a signal from the sensor to the computer.

19. The computer program product of claim 17, wherein the program instructions cause the computer to perform a method comprising the further steps of:
sensing gestures with a sensor operably connected to the computer; and
transmitting a signal from the sensor to the computer.

20. The computer program product of claim 17, wherein the program instructions cause the computer to perform a method comprising the further step of projecting content onto the virtual content display area.
